(19) United States
(12) Patent Application Publication
(10) Pub. No.: US 2014/0281139 A1
(43) Pub. Date: Sep. 18, 2014

(54) DUAL-INTERFACE FLASH DRIVE

(71) Applicant: Leef, Ltd., Alamo, CA (US)

(72) Inventor: David F. Smurthwaite, Alamo, CA (US)

(73) Assignee: Leef, Ltd., Alamo, CA (US)

(21) Appl. No.: 13/844,581

(22) Filed: Mar. 15, 2013

(51) Int. Cl. G06F 1/16; G06F 12/02

(52) U.S. Cl. CPC G06F 1/16; G06F 12/0246
USPC 711/103; 361/679.32

(57) ABSTRACT

Various embodiments relate to apparatuses and methods of dual-interface flash drives which prevent both interfaces of the dual-interface flash drive from being able to be simultaneously connected to interface ports of devices. This eliminates the risk of damage to or malfunction of the dual-interface flash drive as a result of both interfaces being simultaneously connected. As one example, a dual-interface flash drive can include a housing with a standard USB connector on one end and a micro USB connector on the opposite end. A flash memory is embedded within the housing, and a protective shield is attached to the housing. The flash memory is protected from simultaneous access by both the standard USB connector and the micro USB connector by the protective shield physically preventing both connectors from being able to be simultaneously connected to a port of a device

### BACKGROUND

With the continuous advancement of technology, electronic information devices such as personal computers, digital cameras/camcorders, mp3 players, tablets, iPods, iPads, smart phones, and the like have become extremely popular. With this advancement in technology and the associated use of these devices came a corresponding increased use of digital data. The digital data can contain user data, news information, music, TV shows, movies, pictures, videos, etc. Each of these devices may contain one or more different types of digital data, and users often want to share the digital data between these devices. However, many of these devices also have different specifications and sizes, including for the interfaces that they support. A large device, such as a personal computer, can have an interface that uses a large connector such as a standard Universal Serial Bus (USB) connector. A small device, such as a camera, can have a smaller connector, such as a mini USB connector. These different interfaces increase the difficulty of sharing digital data among these devices.

Various interfaces have emerged as standard interfaces in the market place. For example, the standard USB interface is a standard interface for personal computers. A user in possession of a standard USB flash drive, also referred to as a thumb drive, can plug the flash drive into the standard USB connector of nearly all personal computers. The flash drive can be used to copy data from one computer to another computer, via the standard sized USB interface on both computers. However, a standard USB flash drive only enables sharing data between devices that both have standard USB ports. Many of the devices previously referred to do not support a standard USB port, so a standard USB flash drive cannot be readily used to share data between these different devices. A need exists for a flash drive that simplifies the sharing of data between devices that support different types of interfaces, and that can safely and reliably operate when used to share data between different devices.

### SUMMARY

Various embodiments of the present invention are directed to apparatuses and methods of dual-interface flash drives. More specifically, they relate to apparatuses and methods of preventing both interfaces of a dual-interface flash drive from being able to be simultaneously connected to multiple interface ports of devices. This eliminates the risk of damage to or malfunction of the dual-interface flash drive as a result of both interfaces being simultaneously connected. Where two connectors of a flash drive can be simultaneously connected, the two interfaces using the two connectors can attempt to access the flash memory at the same time. For example, the two interfaces can attempt conflicting writes. This could result in corruption of the data in the flash memory or even damage to the dual-interface flash drive. To prevent this, a flash drive that can be simultaneously connected would need special protection circuitry to detect when both interfaces are connected. This protection circuitry would need additional circuitry to prevent any damage or malfunction that could result from both interfaces trying to simultaneously access the flash memory.

Some embodiments of the disclosed apparatus include a housing, a flash memory and a circuit embedded within the housing, and a sliding tray. The sliding tray allows the housing to slide within the sliding tray while also locking the housing within the sliding tray. The housing includes a first connector on a first end of the housing, a second connector on a second end of the housing, the first end and the second end on opposite ends of the housing. The circuit controls a dual-interface. The dual-interface handles communications with external devices via the first connector and the second connector and is electrically connected to the flash memory, the first connector, and the second connector. The flash memory is protected from simultaneous access by both the first connector and the second connector by the sliding tray preventing the first connector and the second connector from being able to be simultaneously connected to a port of a device. As a result, the circuit for controlling the dual-interface may not need circuitry to protect the flash memory from simultaneous access by both the first connector and the second connector. The resulting circuit for controlling the dual-interface can exclude circuitry to protect the flash memory from simultaneous access by both the first connector and the second connector.

The housing can slide on a sliding tray to a first position that enables the first connector to be able to connect to a port of a device, and when it does, the sliding tray can prevent the second connector from being able to connect to the port of the device. The housing can slide to a second position that enables the second connector to be able to connect to the port of the device, and when it does, the sliding tray can prevent the first connector from being able to connect to the port of the device. The first connector can be a standard Universal Serial Bus (USB) connector, and when it is, the port of the device that the first connector is enabled to connect to can be a standard USB connector of a first device. The second connector can be a micro USB connector, and when it is, the port of the device that the second connector is enabled to connect to can be a micro USB connector of a second device.

The circuit for controlling the dual-interface can include an integrated standard USB and micro USB controller. The circuit for controlling the dual-interface can include separate standard USB and micro USB controllers. A first data from the standard USB controller and a second data from the micro USB controller can both connect to a mux, the mux selecting either the first data or the second data to be transmitted to the flash memory. The housing can be removed from the sliding tray. The first connector and the second connector can both be a same type of connector. The flash memory and the circuit can be integrated into one chip.

Some embodiments include methods for copying data from a first device to a second device that include connecting a first connector of a dual-interface flash drive to a port of a first device, copying data from the first device to the dual-interface flash drive, sliding the housing of the dual-interface flash drive to a position that enables the second connector to connect to a port of a second device while simultaneously preventing the first connector from being able to connect to the port of the first device, connecting the second connector to the port of the second device, and copying the data from the dual-interface flash drive to the second device.

Some embodiments of the disclosed apparatus include a housing, a flash memory and a circuit embedded within the housing, and a protective shield attached to the housing. The housing includes a first connector and a second connector. The circuit controls a dual-interface to the first connector and the second connector and is electrically connected to the flash memory, the first connector, and the second connector. The flash memory is protected from simultaneous access by both the first connector and the second connector by the protective shield preventing the first connector and the second connector from being able to be simultaneously connected to a port of a device. The circuit for controlling the dual-interface does not need circuitry to protect the flash memory from simultaneous access by both the first connector and the second connector because the protective shield prevents both connectors from being simultaneously connected.

The protective shield can be movable. When the protective shield is moved to a first position that enables the first connector to be able to connect to a port of a device, the protective shield prevents the second connector from being able to connect to the port of the device. When the protective shield is moved to a second position that enables the second connector to be able to connect to the port of the device, the protective shield prevents the first connector from being able to connect to the port of the device. The first connector can be a standard USB connector, and when it is, the port of the device that the first connector is enabled to connect to can be a standard USB connector of a first device. The second connector can be a micro USB connector, and when it is, the port of the device that the second connector is enabled to connect to can be a micro USB connector of a second device. The circuit for controlling the dual-interface can exclude circuitry to detect when both the first connector and the second connector are connected to ports of devices.

### BRIEF DESCRIPTION OF THE DRAWINGS

Embodiments of the present invention will be described and explained through the use of the accompanying drawings in which:

FIG. 1 illustrates a dual-interface flash drive with the housing in a first position;

FIG. 2 illustrates the dual-interface flash drive of FIG. 1 with the housing in a second position;

FIG. 3 illustrates the dual-interface flash drive of FIG. 1 with the housing in a third position;

FIG. 4A illustrates a top view of the dual-interface flash drive of FIG. 1;

FIG. 4B illustrates a side view of the dual-interface flash drive of FIG. 1;

FIG. 4C illustrates a bottom view of the dual-interface flash drive of FIG. 1,

FIG. 4D illustrates an end view of the dual-interface flash drive of FIG. 1;

FIG. 5 illustrates the dual-interface flash drive of FIG. 1 about to be connected to a smart phone;

FIG. 6 is a flow chart illustrating exemplary operations for copying data from a first device to a second device;

FIG. 7 is a block diagram of a first dual-interface flash drive; and

FIG. 8 is a block diagram of a second dual-interface flash drive.

The drawings are not necessarily drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention are directed to apparatuses and methods of dual-interface flash drives. More specifically, various embodiments of the present invention relate to apparatuses and methods of preventing both interfaces of a dual-interface flash drive from being able to be simultaneously connected to interface ports of devices. This eliminates the risk of damage to or malfunction of the dual-interface flash drive as a result of both interfaces being simultaneously connected. It is not necessary for all embodiments of the invention to have all the advantages of the invention or fulfill all the purposes of the invention.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” “various embodiments,” “some embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

FIG. 1 illustrates a dual-interface flash drive with the housing in a first position in accordance with various embodiments of the present invention. As illustrated in FIG. 1, the dual-interface flash drive includes housing 120 and sliding tray 105. Housing 120 includes a standard USB connector 110 on a first end of housing 120 and a micro USB connector 115 on a second end of housing 120, the first end and the second end on opposite ends of housing 120. Housing 120 has embedded within it a flash memory and a circuit for controlling a dual-interface. The dual-interface supports a standard USB interface via standard USB connector 110, and a micro USB interface via micro USB connector 115. Sliding tray 105 allows housing 120 to slide within the sliding tray while also locking housing 120 within sliding tray 105. Housing 120 is in a first position, which enables standard USB connector 110 to be able to connect to a port of a device. Standard USB connector 110 extends beyond the edge of housing 105 such that it is fully accessible and can be plugged into a port of a first device, for example a standard USB port of a personal computer.

When housing 120 is in this first position, sliding tray 105 acts as a protective shield physically preventing micro USB connector 115 from being able to be connected to a port of a device. Sliding tray 105 extends beyond micro USB connector 115. In this position, sliding tray 105 acts as a protective shield physically preventing micro USB connector 115 from being able to be plugged into a port of a device. For example, when in this first position, micro USB connector 115 cannot be plugged into a smart phone because sliding tray 105 physically prevents a connection from being able to be made. Sliding tray 105 acts as a protective shield physically preventing both standard USB connector 110 and micro USB connector 115 from both being simultaneously connected. For example, this prevents standard USB connector 110 from being connected to a personal computer while micro USB connector 115 is simultaneously connected to a smart phone. Because sliding tray 105 prevents both connectors from being simultaneously connected, the circuit for controlling the dual-interface can be simplified. It can be simplified because it does not need circuitry to protect the flash memory from simultaneous access by standard USB connector 110 and micro USB connector 115. In some of the embodiments, housing 120 can be removed from sliding tray 105.

If both standard USB connector 110 and micro USB connector 115 could be simultaneously connected to ports of devices, it would be possible that both interfaces could attempt to access the flash memory at the same time. This could result in corruption of the data in the flash memory or even damage to the dual-interface flash drive. To prevent this, additional protection circuitry is needed. The circuitry can detect when both interfaces are connected and prevent any damage or malfunction that could result from both interfaces trying to simultaneously access the flash memory. This circuitry is not needed in some of the embodiments due to simultaneous connections being prevented. Sliding tray 105 prevents standard USB connector 110 and micro USB connector 115 from being able to be simultaneously connected to ports of devices. Embodiments which exclude the additional protection circuitry have a lower manufacturing cost, due to die area savings as a result of being able to exclude this circuitry. These embodiments also have a lower design cost, due to the lower complexity of a design that excludes this circuitry.

In some of the embodiments, connectors 110 and 115 can be the same type of connector. For example, connectors 110 and 115 can both be a full size USB connector, a standard USB connector, a standard A-type USB connector, a B-type USB connector, a mini USB connector, a mini USB A-type connector, a mini USB B-type connector, a micro USB connector, a micro USB A-type connector, a micro USB B-type connector, a UC-E6 connector, an Apple Lightning connector, an Apple 30-pin connector, or a Thunderbolt connector. In some of the embodiments, connectors 110 and 115 can be different types of connectors. For example, connectors 110 and 115 can each be a different one of a full size USB connector, a standard USB connector, a standard A-type USB connector, a B-type USB connector, a mini USB connector, a mini USB A-type connector, a mini USB B-type connector, a micro USB connector, a micro USB A-type connector, a micro USB B-type connector, a UC-E6 connector, an Apple Lightning connector, an Apple 30-pin connector, or a Thunderbolt connector.

FIG. 2 illustrates the dual-interface flash drive of FIG. 1 with the housing in a second position in accordance with various embodiments of the present invention. FIG. 1 contains a detailed description of the various parts and labels of FIG. 2. Housing 120 is in a second position, which enables micro USB connector 115 to be able to connect to a port of a device. Micro USB connector 115 extends beyond the edge of housing 105 such that it is fully accessible and can be plugged into a port of a first device, for example a micro USB port of a smart phone.

When housing 120 is in this second position, sliding tray 105 acts as a protective shield physically preventing standard USB connector 110 from being able to be connected to a port of a device. Sliding tray 105 extends beyond standard USB connector 110. In this position, housing 105 acts as a protective shield physically preventing standard USB connector 110 from being able to be plugged into a port of a device. For example, when in this first position, standard USB connector 110 cannot be plugged into a personal computer because sliding tray 105 physically prevents a connection from being able to be made. Sliding tray 105 acts as a protective shield physically preventing both standard USB connector 110 and micro USB connector 115 from both being simultaneously connected. This prevents, for example, standard USB connector 110 from being connected to a personal computer while micro USB connector 115 is simultaneously connected to a smart phone.

FIG. 3 illustrates the dual-interface flash drive of FIG. 1 with the housing in a third position in accordance with various embodiments of the present invention. FIG. 1 contains a detailed description of the various parts and labels of FIG. 3. Housing 120 is in a third position, which prevents both standard USB connector 110 and micro USB connector 115 from being able to connect to a port of a device. When housing 120 is in this third position, sliding tray 105 acts as a protective shield physically preventing both standard USB connector 110 and micro USB connector 115 from being able to be connected to a port of a device. This is because neither connector extends beyond the edge of sliding tray 105. From this third position, sliding housing 120 towards micro USB connector 115 will cause micro USB connector 115 to extend beyond the edge of sliding tray 105. This will enable micro USB connector 115 to be able to be connected to a port of a device. Sliding housing 120 in the opposite direction towards standard USB connector 110 will cause standard USB connector 110 to extend beyond the edge of sliding tray 105. This will enable standard USB connector 110 to be able to be connected to a port of a device.

FIG. 4 illustrates various views of the dual-interface flash drive of FIG. 1. FIG. 1 contains a detailed description of the various parts and labels of FIG. 4. FIG. 4A is a top view of the dual-interface flash drive of FIG. 1. FIG. 4B is a side view of the dual-interface flash drive of FIG. 1. FIG. 4C is a bottom view of the dual-interface flash drive of FIG. 1. FIG. 4D is an end view of the dual-interface flash drive of FIG. 1 when looking head on at micro USB connector 115.

The preceding FIGS. 1-4 all illustrate various aspects of the embodiment of FIG. 1. In this embodiment, sliding tray 105 is a protective shield, physically preventing all but one of the connectors from being able to be connected to ports of devices. Some embodiments can contain three or more connectors. If a dual-interface flash drive has N connectors, at least (N−1) connectors can at all times be physically prevented from being able to be connected to a port of a device by the protective shield that is part of the dual-interface flash drive.

In other embodiments, a different protective shield and housing can be used. For example, rather than being a sliding tray, the protective shield can be a tube or a square, with the housing sliding back and forth within the tube or square. As another example, the protective shield can be a circular disc that rotates around the housing. In this example, the protective shield can have a hole. When the protective shield is rotated such that the hole is aligned with one of the connectors, the connector can be moved such that it protrudes through the hole. In another example, when the protective shield is rotated such that the hole is aligned with one of the connectors, the protective shield can be moved. The protective shield can be pulled back over the connector such that the connector protrudes through the hole. Given the disclosure of the current invention, a person having ordinary skill in the art can determine a variety of shapes and configurations embodying the current invention. The scope of this invention also includes embodiments having these different shapes and configurations. Accordingly, the scope of the present invention is intended to embrace all such alternatives, modifications, and variations as fall within the scope of the claims, together with all equivalents thereof.

FIG. 5 illustrates the dual-interface flash drive of FIG. 1 about to be connected to a smart phone in accordance with various embodiments of the invention. FIG. 1 contains a detailed description of the various parts and labels of dual-interface flash drive 535. Housing 120 is in the second position as illustrated in FIG. 2. In this position, micro USB connector 115 extends beyond the edge of slider tray 105 so that slider tray 105 does not physically prevent micro USB connector 115 from being able to be connected to ports of devices. With micro USB connector 115 in this extended position, dual-interface flash drive 535 can be connected to smart phone 530. Micro USB connector 525 of smart phone 530 is compatible with micro USB connector 115. Being compatible, micro USB connector 115 can be inserted into micro USB connector 525 thereby making a connection between dual-interface flash drive 535 and smart phone 530.

Dual-interface flash drive 535 can be made with any type connector that is physically compatible with dual-interface flash drive 535, and can connect to any device that is compatible with that type connector. For example, dual-interface flash drive 535 can be made with any of the connectors identified in the description of FIG. 1. When made with one of these types of connectors, dual-interface flash drive 535 can connect to any device that is compatible with that type of connector. For example, dual-interface flash drive 535 can be made with an Apple Lightning connector. In this example, dual-interface flash drive 535 can connect to an iPhone 5 which has a compatible Apple Lightning connector. As a second example, dual-interface flash drive 535 can be made with a male mini USB A-type connector. In this example, dual-interface flash drive 535 can connect to a camera which has a female mini USB A-type connector. A female mini USB A-type connector is the connector type that is compatible with a male mini USB A-type connector.

FIG. 6 is a flow chart illustrating exemplary operations for copying data from a first device to a second device in accordance with various embodiments of the present invention. In accordance with some embodiments of the present invention, the method illustrated in FIG. 6 can be performed using a dual-interface flash drive. Illustrated at operation 605 is connecting a first connector of a dual-interface flash drive to a port of a first device. The drawing and description of FIG. 5 provides several examples of operation step 605. For example, the drawing of FIG. 5 illustrates connecting a first connector (i.e. micro USB connector 115) of a dual-interface flash drive (i.e. of dual-interface flash drive 535) to a port (i.e. to micro USB connector 525) of a first device (i.e. of smart phone 530). In the description that follows, the first device will be a smart phone and the second device will be a personal computer (PC). Further, the first connector will be a micro USB connector and the second connector will be a standard USB connector. This is done with the intent of making the description of the method easier to follow.

Operation 610 copies data from the smart phone to the dual-interface flash drive. The data is initially stored in the smart phone. The smart phone reads the data from the storage associated with the smart phone and transmits the data to the dual-interface flash drive via the micro USB connector.

Operation 615 slides the housing of the dual-interface flash drive to a position that enables the standard USB connector to connect to a port of a PC while simultaneously preventing the micro USB connector from being able to connect to the micro USB port of the smart phone. For example, referring to FIGS. 1 and 2, housing 120 is initially in the position of FIG. 2 with micro USB connector 115 extending beyond the edge of sliding tray 105. In this position, micro USB connector 115 is able to be connected to a port of a device. With housing 120 in this position, sliding tray 105 extends beyond standard USB connector 110. In this position, sliding tray 105 acts like a protective shield physically preventing standard USB connector 110 from being able to be connected to a port of a device. Operation 615 as applied to this example slides housing 120 from the position of FIG. 2 to the position of FIG. 1. This change in position of housing 120 enables standard USB connector 110 to be able to connect to the port of the PC while simultaneously preventing micro USB connector 115 from being able to connect to the port of the smart phone. When housing 120 slides from the position of FIG. 2 to the position of FIG. 1, micro USB connector 115 moves from a position where micro USB connector 115 is extended beyond sliding tray 105 to a position where sliding tray 105 is extended beyond micro USB connector 115. In this position, sliding tray 105 acts like a protective shield physically preventing micro USB connector 115 from being able to be connected to a port of a device. Standard USB connector 110 is simultaneously able to be connected to a port of a PC.

Operation 620 connects the standard USB connector of the dual-interface flash drive to the standard USB port of the PC. Continuing with the example of operation 615, standard USB connector 110 is currently in the position of FIG. 1. In this position, standard USB connector 110 is extended beyond the edge of sliding tray 105 and is able to be connected to a port of a device. Operation 620 as applied to this example connects standard USB connector 110 of the dual-interface flash drive to the standard USB port of the PC.

Operation 625 copies the data from the dual-interface flash drive to the PC. Continuing with the example of operation 620, the data is currently stored in the flash memory of the dual-interface flash drive. Standard USB connector 110 is currently connected to the standard USB port of a personal computer. Operation 625 as applied to this example copies the data from the flash memory of the dual-interface flash drive to the personal computer via the standard USB port.

The data referred to in the description of FIG. 6 can be stored any type of storage associated with the first device and/or the second device of this method, including random access memory (RAM), dynamic random access memory (DRAM), flash memory including NAND or NOR flash, SDRAM, SIMM, DIMM, RDRAM, DDR RAM, or any other type of memory device, or can be stored on a hard disk drive, CD ROM, DVD, Blu-ray disc, solid-state drive, removable storage media device such as a USB memory device, a thumb drive, or a flash card.

FIG. 7 is a block diagram of a first exemplary dual-interface flash drive in accordance with various embodiments of the present invention. An exemplary dual-interface flash drive includes standard USB connector 705, micro USB connector 710, NAND flash memory 715, USB/micro USB dual-interface controller 720, and temporary storage memory 725. Standard USB connector 705 can be a male connector, in which case a compatible connector is a female Standard USB connector. A female standard USB connector is, for example, commonly found on personal computers. This connector type, in addition to being referred to as a standard USB connector, is sometimes referred to as a full size USB connector or a standard A-type USB connector. The dual-interface flash drive can be made with any of the connectors listed in the description of FIG. 1 in place of standard USB connector 705 and/or micro USB connector 710. When standard USB connector 705 is connected with a compatible port of a device, the device can communicate with the dual-interface flash drive (i.e. the device can send and receive data and commands to and from the dual-interface flash drive). The device communicates with USB/micro USB dual-interface controller 720 of the dual-interface flash drive.

Micro USB connector 710 can be a male connector, in which case a compatible connector is a female micro USB connector. A female micro USB connector is commonly found in, for example, some smart phones, an example being the Galaxy Nexus from Samsung/Google. When micro USB connector 710 is connected with a compatible port of a device, the device is able to communicate with the dual-interface flash drive. The device communicates with USB/micro USB dual-interface controller 720 of the dual-interface flash drive. NAND flash memory 715 is non-volatile memory that retains data after the dual-interface flash drive is disconnected from power. The dual-interface flash drive can be made with any physically and electrically compatible non-volatile memory in place of NAND flash memory 715, such as NOR flash, EPROM, and EEPROM. NAND flash memory 715 can be implemented as one NAND flash memory chip, or as multiple NAND flash memory chips. NAND flash memory 715 is connected to USB/micro USB dual-interface controller 720.

USB/micro USB dual-interface controller 720 is a single controller that communicates directly with both standard USB connector 705 as well as micro USB connector 710. USB/micro USB dual-interface controller 720 is referred to as “dual” because it is a single controller which can communicate with devices connected to either the standard USB connector 705 or the micro USB controller 710. The dual-interface flash drive can be connected to a device using either standard USB connector 705 or micro USB connector 710. As previously discussed, the dual-interface flash drive cannot be connected to devices using both connectors simultaneously. As a result, the design of USB/micro USB dual-interface controller 720 can be simplified and can require less area relative to other dual-interface flash drive type devices that can be simultaneously connected to two devices. The simplified design can enable a lower design development cost and a corresponding reduced resource requirement to accomplish the design. The reduced area can enable a lower manufacturing cost, as manufacturing cost is directly related to the required area.

When either USB connector 705 or micro USB connector 710 is connected with a compatible port of a device, the device is able to communicate with the dual-interface flash drive. More specifically, the device communicates with USB/micro USB dual-interface controller 720. When a data copy is initiated, such as in operations 610 or 625 of FIG. 6, USB/micro USB dual-interface controller 720 can communicate with the connected device as required to accomplish the copy. When USB/micro USB dual-interface controller 720 receives data, such as in operation 610 of FIG. 6, it can store the data in temporary storage memory 725, to which it is connected. USB/micro USB dual-interface controller 720 can communicate with a device connected to either standard USB connector 705 or micro USB connector 710. This is because USB/micro USB dual-interface controller 720 is a dual-interface controller and it can control communications using either of the two connectors.

NAND flash memory can be read or written in a random access fashion in units typically sized in the range of 2 KB to 4 KB, sometimes called blocks. The data being copied from the connected device can be stored in temporary storage memory 725 until sufficient data has been received to trigger a write of a block of NAND flash memory 715. Once USB/micro USB dual-interface controller 720 has received sufficient data from the connected device, USB/micro USB dual-interface controller 720 can read the data from temporary storage 725 and write the data to the block of NAND flash memory 715. Once the data is written to NAND flash memory 715, the corresponding memory of temporary storage memory 725 can be freed up to be used for other purposes. Additionally, commands that are sent by the connected device can be stored in temporary storage memory 725 until USB/micro USB dual-interface controller 720 is able to handle them appropriately.

As in operation 625 of FIG. 6, USB/micro USB dual-interface controller 720 can send data or commands to a device connected to either standard USB connector 705 or micro USB connector 710. The data to be sent resides in NAND flash memory 715. USB/micro USB dual-interface controller 720 can read the data to be sent from NAND flash memory 715 and store the data in temporary storage memory 715 while it prepares to send the data to the connected device. Once USB/micro USB dual-interface controller 720 is ready to send the data, it can read the data from temporary storage memory 725 and send the data to the connected device. Once the data is sent, the corresponding memory of temporary storage memory 725 can be freed up to be used for other purposes. Additionally, commands that are to be sent by USB/micro USB dual-interface controller 720 can be stored in temporary storage memory 725. Once ready, USB/micro USB dual-interface controller 720 can send the commands to the connected device. Temporary storage memory 725 can be any type of read/write memory, including RAM, DRAM, SRAM, Register Files, Flip Flops, NAND flash, or NOR flash.

USB/micro USB dual-interface controller 720 can also manage the erasing of NAND flash memory 715. Flash memory has “erase blocks”, where an erase block is the smallest unit of flash memory that can be erased at a time. Erase blocks are substantially larger than the smallest unit of memory that can be read or written. For example, NAND flash memory can be read or written in a random access fashion in units typically sized in the range of 2 KB to 4 KB, however, an erase block may be on the order of 256 KB. As a result, when getting ready to erase data or commands from NAND flash memory 715, USB/micro USB dual-interface controller 720 should ensure that only data that is intended to be erased is actually erased. USB/micro USB dual-interface controller 720 can ensure this by managing the data so that the erase block of NAND flash memory 715 to be erased contains exclusively data to be erased. USB/micro USB dual-interface controller 720 can also ensure this by reading the data or commands that are in the erase block to be erased, but are not intended to be erased, and storing the data or commands in temporary storage memory 725. USB/micro USB dual-interface controller 720 can then safely erase the erase block containing the mix of to be erased and not to be erased data/commands. Once the erase block is erased, the data/commands that are not intended to be erased can be read from temporary storage memory 725 and written back to NAND flash memory 715.

FIG. 8 is a block diagram of a second exemplary dual-interface flash drive in accordance with various embodiments of the present invention. An exemplary dual-interface flash drive includes standard USB connector 705, micro USB connector 710, NAND flash memory 715, USB interface controller 820, temporary storage memory 725A, 725B and 725C, micro USB interface controller 830, and flash interface controller 840. Standard USB connector 705, micro USB connector 710, and NAND flash memory 715 are each described in FIG. 7. Temporary storage memory 725A, 725B, and 725C are all similar to temporary memory storage 725 of FIG. 7. When standard USB connector 705 is connected with a compatible port of a device, the device can communicate with the dual-interface flash drive (i.e. the device is able to send and receive data and commands to and from the dual-interface flash drive). More specifically, the device can communicate with USB interface controller 820. When micro USB connector 710 is connected with a compatible port of a device, the device can similarly communicate with the dual-interface flash drive. More specifically, the device can communicate with micro USB interface controller 830.

When a data copy is initiated, such as in operations 610 or 625 of FIG. 6, either USB interface controller 820 or micro USB interface controller 830 can send or receive the data to or from the connected device. Which controller handles the communications with the connected device depends on which connector the device is connected to. USB Interface Controller 820 and micro USB interface controller 830 function similarly, so a description of the function of one controller will enable a person having ordinary skill in the art to practice the other controller. The function of USB interface controller 820 is hence forth described.

When USB interface controller 820 receives data, such as in operation 610 of FIG. 6, it can store the data in temporary storage memory 725A, to which it is connected. NAND flash memory can be read or written in a random access fashion in units typically sized in the range of 2 KB to 4 KB, sometimes called blocks. The data being copied from the connected device can be stored in temporary storage memory 725A until sufficient data has been received to trigger a write of a block of NAND flash 715. The data can be sent to Flash interface controller 840, where it can be stored in temporary storage memory 725C sufficient data has been received to trigger a write of a block of NAND flash 715. Once sufficient data has been received to trigger a write, the temporary storage memory storing the data can be read and the data can be sent to flash interface controller 840. Flash interface controller 840 can write the data to the block of NAND flash 715. Once the data is written to NAND flash memory 715, the corresponding memory of the temporary storage memory holding the data can be freed up to be used for other purposes. Additionally, commands that are sent by the connected device can also be stored in temporary storage memory 725A until USB interface controller 820 is able to handle them appropriately.

As in operation 625 of FIG. 6, USB interface controller 820 can send data. The data to be sent resides in NAND flash memory 715. Flash interface controller 840 can read the data to be sent from NAND flash memory 715 and store the data in temporary storage memory 725C. Flash controller 840 can send the data to USB interface controller 820, which can store the data to be sent in temporary storage memory 725A. Once USB interface controller 820 is ready to send the data to the connected device, it can read the data from temporary storage memory 725A and send the data to the connected device. Additionally, commands that are to be sent can be stored in temporary storage memory 725A until USB interface controller 820 is ready to send the commands to the connected device.

Flash interface controller 840 can also manage the erasing of NAND flash memory 715. Flash memory has “erase blocks”, which creates certain issues that are discussed in FIG. 7. When getting ready to erase data or commands from NAND flash memory 715, flash interface controller 840 should ensure that only data that is intended to be erased is actually erased. Flash interface controller 840 can ensure this by managing the data so that the erase block of NAND flash memory 715 to be erased contains exclusively data to be erased. Flash interface controller 840 can also ensure this by reading the data or commands that are in the erase block to be erased, but are not intended to be erased, and storing the data or commands in temporary storage memory 725C. Flash interface controller 840 can then safely erase the erase block containing the mix of to be erased and not to be erased data/commands. Once the erase block is erased, the data/commands that are not intended to be erased can be read from temporary storage memory 725C and written back to NAND flash memory 715.

Given the block diagram and associated detailed description of the embodiment of FIG. 7, and the block diagram and above description of FIG. 8, a person having ordinary skill in the art is able to practice the embodiment of the invention depicted in FIG. 8. Additionally, a person having ordinary skill in the art will appreciate that there are various other ways to implement the described functionality. The scope of this invention also includes embodiments implementing the described functionality in these various other ways. Accordingly, the scope of the present invention is intended to embrace all such alternatives, modifications, and variations as fall within the scope of the claims, together with all equivalents thereof.

Numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

### CONCLUSION

In conclusion, the present invention provides novel apparatuses, methods, and arrangements for a dual-interface flash drive. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A dual-interface flash drive comprising:
a housing including a first connector on a first end of the housing, a second connector on a second end of the housing, the first end and the second end on opposite ends of the housing;
a flash memory embedded within the housing;
a circuit for controlling a dual-interface to the first connector and the second connector embedded within the housing and electrically connected to the flash memory, the first connector, and the second connector; and
a sliding tray that allows the housing to slide within the sliding tray while also locking the housing within the sliding tray, wherein the flash memory is protected from simultaneous access by both the first connector and the second connector by the sliding tray preventing the first connector and the second connector from being able to be simultaneously connected to a port of a device, whereby the circuit for controlling the dual-interface does not need circuitry to protect the flash memory from simultaneous access by both the first connector and the second connector because the sliding tray prevents both connectors from being simultaneously connected.

2. The dual-interface flash drive of claim 1, wherein the circuit for controlling the dual-interface excludes circuitry to protect the flash memory from simultaneous access by both the first connector and the second connector.

3. The dual-interface flash drive of claim 1, wherein when the housing slides to a first position that enables the first connector to be able to connect to a port of a device, the sliding tray prevents the second connector from being able to connect to the port of the device, wherein when the housing slides to a second position that enables the second connector to be able to connect to the port of the device, the sliding tray prevents the first connector from being able to connect to the port of the device.

4. The dual-interface flash drive of claim 3, wherein the first connector is a standard Universal Serial Bus (USB) connector, wherein the second connector is a micro USB connector, wherein the port of the device that the first connector is enabled to connect to is a standard USB connector of a first device, wherein the port of the device that the second connector is enabled to connect to is a micro USB connector of a second device.

5. The dual-interface flash drive of claim 4, wherein the circuit for controlling the dual-interface includes an integrated standard USB and micro USB controller.

6. The dual-interface flash drive of claim 4, wherein the circuit for controlling the dual-interface includes separate standard USB and micro USB controllers, a first data from the standard USB controller and a second data from the micro USB controller both connecting to a mux, the mux selecting either the first data or the second data to be transmitted to the flash memory.

7. The dual-interface flash drive of claim 1, wherein the housing can be removed from the sliding tray.

8. The dual-interface flash drive of claim 1, wherein the first connector and the second connector are both a same type of connector.

9. The dual-interface flash drive of claim 8, wherein the same type of connector is one of a full size USB connector, a standard USB connector, a standard A-type USB connector, a B-type USB connector, a mini USB connector, a mini USB A-type connector, a mini USB B-type connector, a micro USB connector, a micro USB A-type connector, a micro USB B-type connector, a UC-E6 connector, an Apple Lightning connector, an Apple 30-pin connector, or a Thunderbolt connector.

10. The dual-interface flash drive of claim 1, wherein the flash memory and the circuit are integrated into one chip.

11. A method for copying data from a first device to a second device comprising:
connecting a first connector of a dual-interface flash drive to a port of the first device, the dual-interface flash drive including a sliding tray that allows a housing to slide within the sliding tray while also locking the housing within the sliding tray, wherein a flash memory embedded in the housing is protected from simultaneous access by the first connector on a first end of the housing and a second connector on a second end of the housing by the sliding tray preventing the first connector and the second connector from being able to be simultaneously connected to ports;
copying data from the first device to the dual-interface flash drive;
sliding the housing of the dual-interface flash drive to a position that enables the second connector to connect to a port of the second device while simultaneously preventing the first connector from being able to connect to the port of the first device;
connecting the second connector of the dual-interface flash drive to the port of the second device; and
copying the data from the dual-interface flash drive to the second device.

12. The method of claim 11, wherein the first connector is a standard USB connector and the second connector is a micro USB connector.

13. The method of claim 12, wherein the port of the second device that the second connector is enabled to connect to is a micro USB connector, and wherein the port of the first device that the first connector is simultaneously prevented from connecting to is a standard USB connector.

14. The method of claim 11, wherein the first connector and the second connector are both a same type of connector.

15. The method of claim 14, wherein the same type of connector is one of a full size USB connector, a standard USB connector, a standard A-type USB connector, a B-type USB connector, a mini USB connector, a mini USB A-type connector, a mini USB B-type connector, a micro USB connector, a micro USB A-type connector, a micro USB B-type connector, a UC-E6 connector, an Apple Lightning connector, an Apple 30-pin connector, or a Thunderbolt connector.

16. A dual-interface flash drive comprising:
a housing including a first connector and a second connector;
a flash memory embedded within the housing;
a circuit for controlling a dual-interface to the first connector and the second connector embedded within the housing and electrically connected to the flash memory, the first connector, and the second connector; and
a protective shield attached to the housing, wherein the flash memory is protected from simultaneous access by both the first connector and the second connector by the protective shield preventing the first connector and the second connector from being able to be simultaneously connected to a port of a device, whereby the circuit for controlling the dual-interface does not need circuitry to protect the flash memory from simultaneous access by both the first connector and the second connector because the protective shield prevents both connectors from being simultaneously connected.

17. The dual-interface flash drive of claim 16, wherein the protective shield is movable, wherein when the protective shield is moved to a first position that enables the first connector to be able to connect to a port of a device, the protective shield prevents the second connector from being able to connect to the port of the device, wherein when the protective shield is moved to a second position that enables the second connector to be able to connect to the port of the device, the protective shield prevents the first connector from being able to connect to the port of the device.

18. The dual-interface flash drive of claim 17, wherein the first connector is a standard USB connector, wherein the second connector is a micro USB connector, wherein the port of the device that the first connector is enabled to connect to is a standard USB connector of a first device, wherein the port of the device that the second connector is enabled to connect to is a micro USB connector of a second device.

19. The dual-interface flash drive of claim 16, wherein the first connector and the second connector are movable, wherein when the first connector is moved to a first position that enables the first connector to be able to connect to a port of a device, the protective shield prevents the second connector from being able to connect to the port of the device, wherein when the second connector is moved to a second position that enables the second connector to be able to connect to the port of the device, the protective shield prevents the first connector from being able to connect to the port of the device.

20. The dual-interface flash drive of claim 16, wherein the circuit for controlling the dual-interface excludes circuitry to detect when both the first connector and the second connector are connected to ports of devices.
